(19) United States
(12) Patent Application Publication
(10) Pub. No.: US 2011/0246378 A1
(43) Pub. Date: Oct. 6, 2011

(54) IDENTIFYING HIGH VALUE CONTENT AND DETERMINING RESPONSES TO HIGH VALUE CONTENT

(76) Inventors: E. Fredrick PRUSSACK, New York, NY (US); Greg Gianforte, Bozeman, MT (US); Douglas K. Warner, Bozeman, MT (US); David A. Vap, Bozeman, MT (US)

(21) Appl. No.: 12/750,017

(22) Filed: Mar. 30, 2010

(51) Int. Cl. G06Q 99/00; G06Q 10/00; G06Q 30/00; G06F 17/30; G06F 15/16

(52) U.S. Cl. 705/310; 705/343; 705/347; 707/748; 709/217; 707/E17.014

(57) ABSTRACT

Systems and methods automatically determine responses to content based on semantic analysis, token analysis and influence ratings. The systems and methods identify relevant queries for product support, purchase or advocacy from multiple communications channels and further separate the high-value conversations and individuals from the low value conversations and individuals in an efficient manner. Described herein is a system and method to use the identification of important individuals and the context of their conversations to appropriately route content items and messages and subsequent responses in such a way as to allow an efficient interaction to occur.

### FIELD

This disclosure relates generally to systems and methods for content analysis, more particularly, to automatically determining responses to content based on semantic analysis, token analysis and influence ratings.

### BACKGROUND

As the internet and smart phones alter modern communication it becomes more difficult to simply monitor a single source channel for relevant information to an individual or company. The combined problems of (1) individuals using multiple channels for their communication, such as email, phone, (micro) blogging and social networking sites and (2) identifying the important information flowing across each of those channels while (3) ignoring the inherent noise of each channel increases rather than decreases the amount of effort one must use to engage effectively.

Search engines such as Google™ and Bing™ offer some ability to collect disparate sources of information and make them available via queries. However, with these solutions there is ample noise that must still be filtered through manually, such as whether the emotional tone of the information is positive or negative or whether the information is offered as an opinion or a request for help.

### BRIEF DESCRIPTION OF THE DRAWINGS

For a better understanding of the present invention, reference may be made to the accompanying drawings in which:

FIG. 1 is a block diagram of a system according to embodiments of the invention;

FIGS. 2A-2C are flowcharts illustrating methods for performing actions in accordance with content analysis according to embodiments of the invention;

FIG. 3 is a block diagram of an example embodiment of a computer system upon which embodiments inventive subject matter can execute.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the invention should correspond to the Figure number in which the item or part is first identified.

The description of the various embodiments is to be construed as exemplary only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to a company customer support department that accepts multiple textual channels as a means of customer communication. This is only one example of a suitable environment and is not intended to suggest any limitation as to the scope of use or functionality of the invention. Neither should it be interpreted as having any dependency or requirement relating to any one or a combination of components illustrated in the exemplary operating environment.

In general, various embodiments combine, in a cross-channel environment, token recognition, semantic analysis with influencer identification with workflow and optionally with proprietary data about the originator of the content. This system aids in prioritizing how to respond to content, and to filter important information from a larger body of unimportant information.

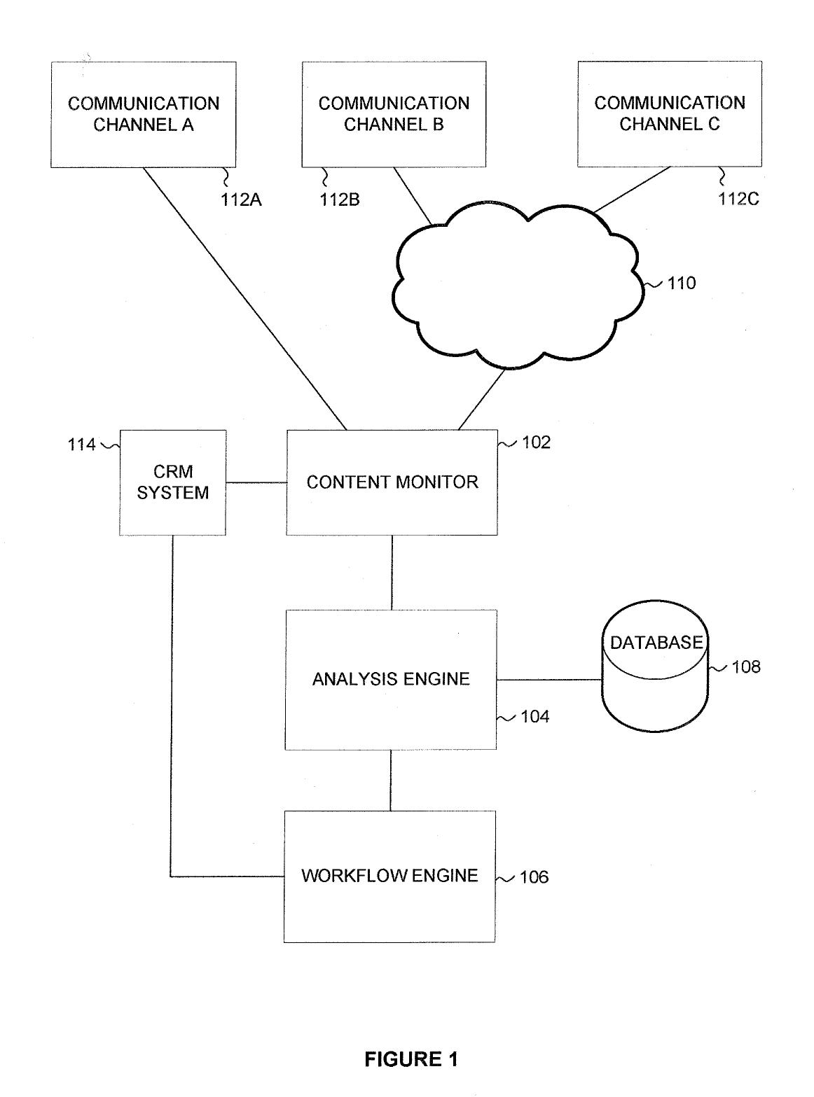

FIG. 1 is a block diagram of a system 100 according to embodiments of the invention. In some embodiments, system 100 includes a content monitor 102, an analysis engine 104 and a workflow engine 106. Content monitor 102 receives content items from various communication channels 112 and selects various communications items for further processing. The selection of communications items may be based on various parameters, including search terms and/or the presence of various tokens in a content item.

A communications channel 112 can be any system that can post or deliver a content item. Thus communications channels may include web sites, social networking services, audio channels (over networks of phone lines), video channels etc. Examples of such communication channels and their corresponding content item are listed below in Table 1.

TABLE 1

| Communications Channel | Content Item |
|---|---|
| Email system | Email message |
| Twitter | Tweet |
| Facebook | Posting, chat, comments |
| Blog | Posting |
| Web Site | Web page, posting |
| RSS (Really Simple Syndication) | RSS Feed |
| Phone | Audio (recorded for analysis) |

Table 1 is not meant to provide an exclusive listing of communication channels and content items, those of skill in the art will appreciate that other forms exist and may be developed in the future. Further, various embodiments of the invention may utilize different combinations of communication channels and content items. The various communication channels 112 have different limitations and characteristics. For example, a phone channel is limited to auditory information and is primarily (in the absence of conference calling) limited to one-on-one conversations, whereas email is limited to textual and/or graphical information and is primarily (in the absence of distribution lists) limited to one-on-one conversations, whereas microblogging sites such as Twitter are limited to 140 characters of textual information but are distributed via broadcast to anyone. Clearly innumerate alternate variations exist, but it is notable that various communication channels can be auditory, visual or textual (alone or in combination) and be directed towards one-on-one communication, small group communication or broadcast communication.

Communication channels may be directly connected (e.g., a phone line) or they may be connected via a broadcast medium such as a network 110 (wired or wireless). Network 110 may be a collection of networks such as the Internet.

Some embodiments of the invention include an analysis engine 104 that receives selected content items from content monitor 102 and applies various heuristics to content items in order calculate various parameters regarding the content item. Such parameters may include a sentiment value for a content item, an influencer rating for the content item, and in some embodiments, a business value associated with the content item.

In some embodiments, analysis engine 104 may access a database 108 to obtain data useful in calculating the parameters described above. Such data may include proprietary data that a business has accumulated about customers, users or other entities. In some embodiments, such proprietary data may include any of the following, alone or in combination: number of support incidents, status of support incidents, disposition of support incidents, rate of support incidents, lifetime customer value, page views on a corporate system, clickthrough rates on marketing campaigns, sharing rates of marketing campaigns, most recent purchase amount, purchase history dates, active purchase negotiations, marketing opt-in values, net promoter score, responses to survey questions, likelihood to buy indicators, demographic information, current service level agreements, and warranty status. One of ordinary skill in the art will appreciate that additional proprietary data may be available and useful, and that no limitation is implied or inferred by the herein described list.

Workflow engine 106 receives parameters related to content items and determines an action with respect to the content item based on the parameters. In general, workflow engines are known in the art, and typically include the ability to handle service level agreements (SLAs) to prioritize and route customers of varying levels to the appropriate work queues, skills based routing (SBR) to allow items to route to individuals with the appropriate skills to handle that item, automated search functionality that attempts to automatically match the item with reusable content, escalation ability to move items from one queue or assignment into another if specific business conditions are met, and many other standard business practices. Some of these techniques are very simple rules such as IF customer=’John Doe’ THEN assign_item=PRIORITY_QUEUE, while others may be very complex, such as IF item MATCHES_BY_NATURAL_LANGUAGE_ANALYSIS product_A THEN assign_item=PRODUCT_A_QUEUE. Natural language analysis can include any number of very complex operations. Other complexities include automatic identification of content for matching skill sets (SBR) and the like. Finally, workflow engines in the art typically provide the ability to combine multiple conditions and actions into a single rule. Other functionalities may be provided in standard workflow engines. Some embodiments provide functionality and/or modifications that are not found in workflow engines known in the art. For example, in some embodiments, workflow engine 106 provides coupling with the large variety of communications channels as well as any specific information provided by a sentiment and/or influencer analysis. Such coupling includes the ability (either automatically or by setting the default channel for a human response) to respond in the source communications channel or via an alternate communications channel as defined by the rules constructed in the system, to update any analysis engine calculations that the workflow has determined may be inaccurate, to restrict the length of response or add additional requirements or data fields based on meta-data about the response channel and additional similar modifications that are not part of workflow engines known in the art. This list of functionality and modifications above is not exhaustive and one of ordinary skill in the art can identify additional conditions and actions that apply when monitoring and analyzing content from numerous external sources.

Some embodiments of the invention may contain a Customer Relationship Management (CRM) system 114. CRM system 114 may be used for various purposes. In some embodiments, CRM system may supply content monitor with terms such as company names, product names, service names etc. that may be obtained from a catalog maintained by the CRM. In addition, CRM may receive updates, queue entries, task requests etc. as a result of actions performed by the workflow engine 106.

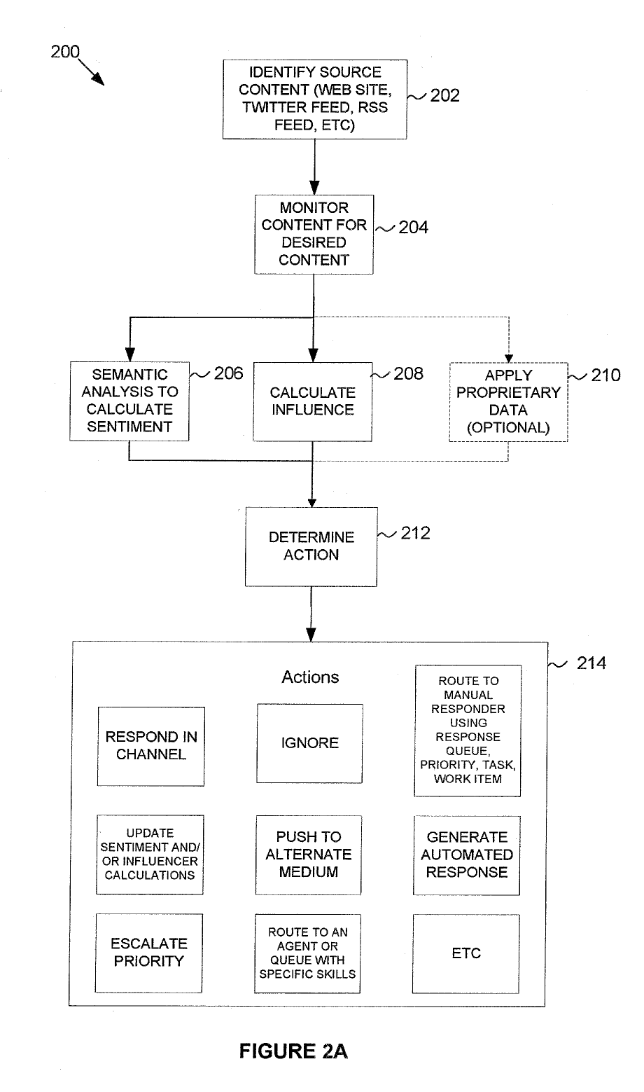

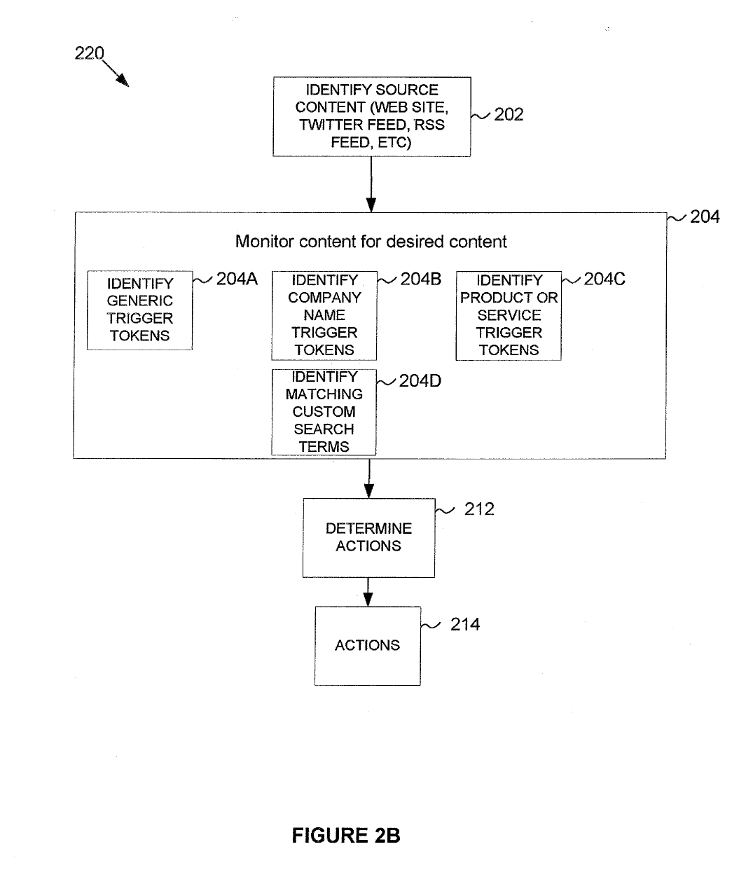

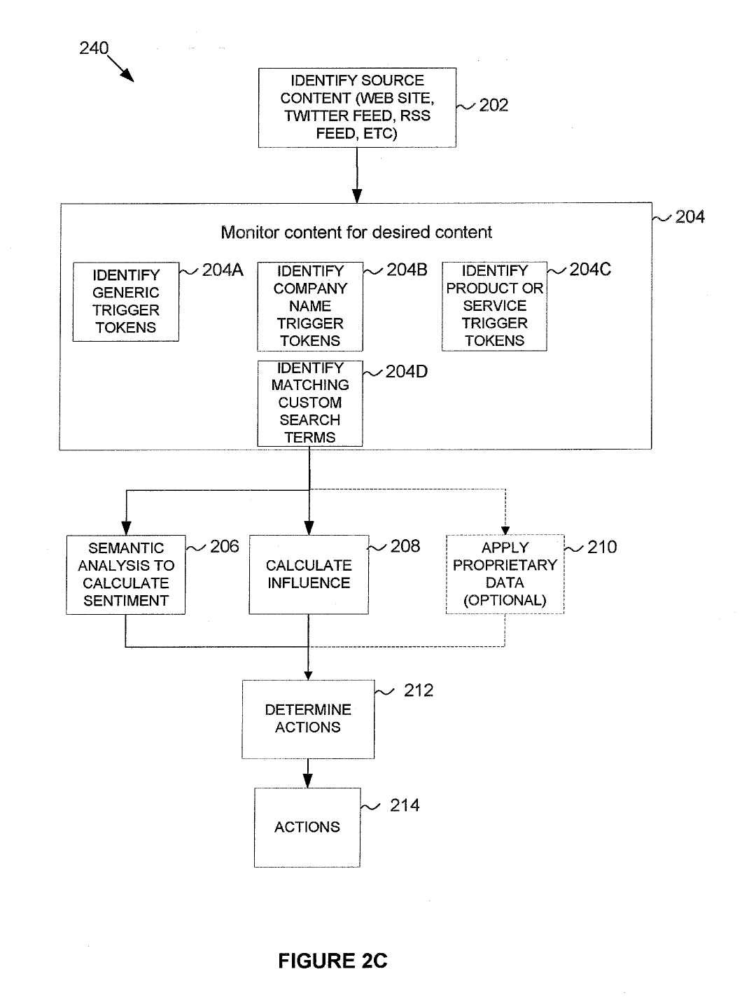

Further details on the operation of the above described components are described below with respect to FIGS. 2A-2C. FIGS. 2A-2C are flowcharts describing methods according to various embodiments. The methods may, in some embodiments, constitute computer programs made up of computer-executable instructions. Describing the methods by reference to a flowchart enables one skilled in the art to develop such programs including such instructions to carry out the method on suitable processors (the processor or processors of the computer executing the instructions from machine-readable media). The methods illustrated in FIGS. 2A-2C are inclusive of acts that may be taken by an operating environment 100 executing an exemplary embodiment of the invention.

FIG. 2A is a flowchart illustrating a method 200 for determining actions based on content analysis according to embodiments of the invention. Method 200 begins at block 202 with identifying a source communication channel for content items. Once identified, the system may connect to the desired source to receive content items from the communication channel.

At block 204, the method monitors content items received from a communication channel to determine if the content item is of interest (i.e., to determine if the content item is to be further processed). In some embodiments, determining if a content item is of interest may involve searching the content item for the presence of search terms or tokens, or using other techniques that may be provided by the communication channel (e.g., subscription to a particular topic etc.).

If the content is selected for further processing, the method proceeds to execute blocks 206, 208 and optionally, block 210.

At block 206, the system performs a sentiment calculation for the content item. In general, a sentiment calculation determines if the emotional tone of the content item is positive or negative with respect to a desired subject, product, service etc. In some embodiments, semantic analysis is applied to the content item. The term semantic analysis includes determining the emotional content of textual information. Semantic analysis may also include determining general descriptions of value, quality, likelihood to buy indicators, support questions vs. opinion positions, and the like, and are included in this definition. Similarly, semantic analysis may be performed on non-textual data such as voice, music or even images and video and no limitation is implied or inferred to relate only to textual content. Further details on the application of semantic analysis that may be used in various embodiments of the invention may be found in U.S. Pat. No. 7,289,949 co-authored by one of the current inventors, which is hereby included in its entirety by reference herein for all purposes.

At block 208, the system calculates an influence rating for the content item. In the some embodiments, an influence rating is associated with an identified influencer, e.g., the individual that was the source of the content. The influence rating captures relevant aspects of the individual behind the content, and may comprise any of the following alone or in weighted combination: number of posts in the current channel, % of relevant posts vs. total posts, number of followers, size of network (number of followers+number following), size of network (number of followers vs. number following), number of views of posts, quality of followers, length of post, linguistics of post (adverbs, strong tone, etc), multi-lingual nature of post, geographical distribution of followers, completeness of poster description (avatar, biography, etc), frequency of posts, frequency of relevant posts, identified or verified in other channels, rate of contribution on other channels, relative ranking in the system, click through rates on relevant ads, click through rates on marketing communications, community reputation. One of ordinary skill in the art will appreciate that additional components that may define all or part of an influence rating calculation and no limitation is implied or to be inferred by the herein described list.

In some embodiments, block 210 may be executed. At block 210, the system obtains proprietary data about the person or entity that was the source of the content item (e.g., an influencer). The proprietary data may be used in some embodiments to determine a contextual interpretation of the content item or author of the content or to determine a business value associated with the person or entity that was the source of the content item. Examples of the data that may be used in such a determination have been described above with reference to database 108.

At block 212, an action is determined based on the semantic analysis, the influence rating and optionally, the business value. For example, the outputs of blocks 206, 208 and optionally, 210 may be used to determine if a response is warranted, and if so, which channel is the appropriate channel in which to respond (the originating channel or an alternate channel). In some embodiments, the actions 214 that may be performed include various combinations of one or more of the following:
Respond to the content item in the same communication channel
Respond to the content item in a different communication channel
Update one or more parameters used to calculate sentiment or influence rating
Escalate a priority for a work item, trouble ticket etc.
Push the content to an alternate medium
Route the content item to an Agent with specific skills to handle the content item (e.g., through a queue)
Route the content item for manual response (e.g., through a queue, work item, task, priority etc.)
Generate an automated response
Ignore the content item
   Those of skill in the art will appreciate that other actions may be performed and such actions are within the scope of the inventive subject matter.

In some embodiments, a communications channel for a response to a content item may be selected in accordance with various characteristics of the response. For example, while a content item may be received via Twitter (and thus limited to 140 characters of text) response content may utilize more than 140 characters of text, or may contain audio or graphics. In such cases, a communications channel for the response may be selected that is appropriate to the characteristics of the desired response. Additionally, a characteristic of the response may include whether the response is directed to the author of the content item (e.g., an email, phone call etc.) or whether the response is to be broadcast such that it is available to multiple parties (e.g., posting on a web page, RSS, Twitter etc)

FIG. 2B is a flowchart illustrating a method 220 for determining actions based on content analysis according to embodiments of the invention. As with method 200 above, method 220 begins at block 202 with identifying a source communication channel for content items. Once identified, the system may connect to the desired source to receive content items from the communication channel.

At block 204, the method monitors content items received from a communication channel to determine if the content item is of interest (i.e., to determine if the content item is to be further processed). In some embodiments, determining if a content item is of interest may involve various combinations of one or more of the operations indicated at blocks 204A, 204B, 204C and 204D.

At block 204A, the system analyzes the content item for generic trigger tokens. Examples of such trigger tokens include generic terms such as “help” “install” “configure” “problem” “trouble” and the like.

At block 204B, the system analyzes the content item to determine if a desired company name appears in the content item. The company names of interest may be configured into the system, or they may be automatically obtained from various sources, including customer support applications or CRM system 114.

At block 204C, the system analyzes the content item to determine if a desired product name token or service name token appears in the content item. Again, the product or service name tokens may be configured or may be automatically obtained or extracted from a product catalog.

At block 204D, the system determines if the content item contains custom search terms.

As an example of the above, tokens that are relevant to a specific customer support installation, such as company or product names: “Nikon” or “Nikon D90” or “Harley Davidson Sportster” or “Harley Davidson” may be determined to be of interest. Resulting tokens could then potentially be: “help $PRODUCT_NAME” where $PRODUCT_NAME is automatically substituted by the system using product name values from the product catalog stored in the system or even just $COMPANY_NAME or $PRODUCT_NAME without the generic term. Similarly, the generic terms may also include non-words or word/acronym combinations such as “RN-HELP” or other variations that may be marketed to a population to use as an explicit request trigger. One of ordinary skill in the art can clearly see the scope of the generic terms is not limited to those listed and may include many different alternatives. Similarly, tokens such as company and product names may come from alternate sources within the system and not just the product catalog, and further may include non-product services such as those offered by travel agents or health care professionals, among others.

The parameters determined by any of blocks 204A-D may then be used at block 212 to determine an action (for example, using a configurable workflow engine designed to handle such parameters and generate actions 214).

It should be noted that one or more of blocks 204A-D need not be executed by some embodiments. For example, in FIG. 2A, block 204D may be executed to determine desired content while blocks 204A-C need not be present or executed.

FIG. 2C is a flowchart illustrating a method 240 for determining actions based on content analysis according to embodiments of the invention. In general, method 240 combines elements of methods 200 and 220. Method 240, like methods 200 and 220 above, begins at block 202 with identifying a source communication channel for content items. Once identified, the system may connect to the desired source to receive content items from the communication channel.

Next, at block 204, including one or more of blocks 204A-D may be executed to determine if a content item from a source communication channel is of interest. The functionality provided by blocks 204A-D has been described above.

Next, blocks 206, 208, and optionally block 210 may be executed to provide semantic analysis, influence rating, and optionally proprietary data as described above with reference to FIG. 2A. The results of blocks 206, 208 and optionally, block 210 may then be used at block 212 to determine one or more actions 214 with respect to a content item. The functionality provided by blocks 206, 208 and 210 has been described above with reference to FIG. 2B.

The following examples are provided to illustrate the operation of the above described systems and methods.

### Example 1

John the consumer of a cordless drill experiences a malfunction. He posts on Twitter a message like, “My ACME cordless drill just started making a terrible grinding sound! Help!” As part of ACME's business, they have determined that Twitter is a valuable channel for them to monitor. They regularly monitor the custom search term “ACME cordless drill” as well as other relevant terms for their business. The system discovers a match in John's post and sends it to the Analysis Engine. In the Analysis Engine the Sentiment is determined to be moderately negative due to the terms “grinding sound” and “help” along with the exclamation marks and the “terrible” modifier. The Engine determines this moderately negative post is out of character for John, who normally posts neutral to mildly positive content on Twitter. The Influencer portion of the Engine discovers John to have 5840 posts and 127,032 followers, with many of John's followers similarly prolific. The influencer portion of the Engine further finds John's profile is complete with a connection to his corporate identity, which is cross-identified to his role as a TV host of a home improvement show. The Engine subsequently determines John to be an “influencer.” Finally, the Engine checks John's credentials within the ACME CRM system and discovers that John has submitted 10 trouble tickets within the last 6 months and has purchased the full range of ACME tools for a lifetime value of over $10,000. This data is then forwarded to the workflow engine where the ACME business administrator has configured a rule which states, “IF post=negative sentiment AND poster=significant_influencer AND poster IN CRM AND poster_lifetime_value>$1000 THEN create_trouble_ticket AND set_contact_channel=phone AND assign_trouble_ticket=priority_queue”. The result is that the system creates a trouble ticket in the ACME CRM system with the content of the Twitter post, assigned to the priority queue with John's information attached. When the support agent Sue, who monitors the priority queue, reads the trouble ticket she identifies the system has indicated to respond via phone and so she calls John on his cell phone to resolve the drill issue. John answers his cell phone to find ACME calling about his Twitter post. John is surprised that ACME has been monitoring his preferred Twitter channel, and also by the rapid response time of less than 5 minutes, so John's devotion to ACME increases even though Sue determined that the drill is both out of warranty and has simply been used too much so needs to be replaced at John's cost.

### Example 2

Instead of monitoring a custom search term, ACME's CRM system automatically monitors on the tokens “ACME” (automatically extracted from the CRM configuration) “cordless drill” (automatically extracted from the CRM product catalog) and “help” (a generic trigger token for customer support). These automatic queries simplify the configuration and monitoring of the source content, but otherwise the remainder of the system functions as in Example 1.

### Example 3

Bob is a curmudgeon who habitually complains about all his business interactions. He decides he has had a negative experience with a ticket agent of FlybyNite Airlines, so he posts a scathing video on YouTube™. FlybyNite happens to monitor YouTube™ because other airlines have experienced negative business impacts due to YouTube™ posts. They monitor YouTube™ with custom searches for their brand name and the system discovers Bob's video and sends the post to the Analysis Engine. The sentiment calculation discovers the profanity-laced content to be no different than Bob's normal posting content. The influencer calculation discovers that Bob only has 2 subscribers and a total of 10 views on his entire body of work and so determines Bob to not be an influencer. This data is the forwarded to the workflow engine where the FlybyNite business administrator has created a rule which states, “IF post<positive sentiment AND poster=no_influence THEN ignore”. There is no further action taken in the FlybyNite CRM system and no response is made to Bob, allowing FlybyNite to dedicate staff resources more efficiently.

### Example 4

Instead of manually adding a custom search term on their company name, FlybyNite's CRM system comes pre-configured to automatically monitor their company name. FlybyNite was woefully unaware of the power of social media channels, so they did not even think to monitor YouTube; luckily their CRM system's automatic identification of their company name identified and escalated Bob's complaints. FlybyNite was able to then create a workflow rule that allowed them to explicitly ignore curmudgeons as in Example 3.

### Example 5

Sally purchases a new uPhone and discovers a set of features she never expected by really likes. She decides to post several paragraphs about her new uPhone and these features on her family blog site at familyblogs.com. uPhone has decided to use custom search teems to monitor all blogs on familyblogs.com for any posts mentioning it's brand because it has determined that familyblogs.com represents a valuable demographic to uPhone. The system discovers Sally's post because of the uPhone reference and sends it to the Analysis Engine for sentiment calculation. The sentiment is determined to be very positive. The influencer calculation discovers that this is Sally's 5th post and that she has 20 followers. The uPhone CRM system is able to determine that Sally has registered her uPhone and she has purchased only the uPhone and one accessory and clicks through 60% of the marketing communications from uPhone. This data is then forwarded to the workflow engine where the uPhone administration team has created a rule which states, “If post=very positive sentiment AND poster IN CRM AND poster_CRM_state=good_standing THEN auto_respond IN source_channel USING thankyou_message”. Upon processing this rule the system automatically posts the pre-constructed “Thank you for using the uPhone.” message on Sally's blog in the comments section of the blog using the uPhone corporate account on familyblogs.com. There is no further action taken by uPhone, allowing uPhone staff to work high priority items.

### Example 6

As in example 4, uPhone's Customer Support system automatically identified the company name and added it to the monitoring list. uPhone administrators only had to identify the source content as familyblogs.com and configure a general workflow for determining how to route and respond to the familyblogs.com channel, but they did not need to worry about their brand or product-specific monitoring as that information was automatically extracted from their Customer Support system.

### Example 7

Sam just purchased a new computer game called Bouncers from Gameslinger and has found device conflicts on his computer when he installed the game. He posts on gamers.com microblogging site, “Bummer. Gameslinger's Bouncers crashes my system. [symbol] (frowning emoticon)” Gameslinger monitors gamers.com due to the large number of garners who post there. Curiously, gamers.com limits post sizes to 128 characters. The system discovers the gamers.com post because of the custom search term Gameslinger is using to monitor its company name and Bouncers product and determines Sam's post is moderately negative due to the words “bummer” and “crashes” as well as the frowning emoticon “ [symbol] ”. The analysis engine determines that Sam posts an average amount on the site and does not stand out from others as an influencer. The engine also discovers that there is no clear connection between Sam's gamers.com identification and a record in the Gameslinger CRM database. This information is passed to the workflow engine which discovers the following matching rule: “IF sentiment<positive AND crm_record=missing AND influencer<top_tier AND source_channel=(gamers.com OR Twitter) THEN create_trouble_ticket AND assign_trouble_ticket=normal_queue AND auto_respond IN source_channel USING short_ticket_reference”. In this case the system creates a trouble ticket with Sam's post and assigns it to a support agent in the normal queue. A notification goes out on gamers.com to Sam saying, “We see your problem. Please resolve with us at http://shorturl.com/ticket5475”. Sam clicks on the link and is brought to the Gameslinger support site with a trouble ticket pre-created with Sam's post and his gamers.com user record pre-populated and is prompted to complete his contact record and elaborate on the trouble he is having. This information then enters the normal work queue for Gameslinger and is processed through normal channels.

### Example 8

Gameslinger's Support system automatically identifies the Gameslinger company name from the product configuration and the Bouncers game from the product catalog. Gameslinger simply specifies to monitor the gamers.com site and configure the workflow rule and monitoring is fully functional as in example 7.

### Example 9

Susan is curious about a new robot dog walker. Her friends have told her many good things about the work savings and low cost. Susan decides to post on the gadgets.com site, “Heard all about the RobotWalker. I REALLY WANT one! How much are they and where can I buy one?” Of course myRobot Corporation monitors the gadgets.com site for their products via several custom search terms and the system finds a reference to their new product, RobotWalker. This post is processed through the Analysis Engine which analyzes the sentiment to discover a very high likelihood to buy based on the emphasized “REALLY WANT one” language coupled with the price and location query. The Influencer calculation discovers Susan is a regular reviewer of products on gadget.com with more than 10 product reviews, each review having hundreds of marks indicating her review was useful, but does not find a completed profile for Susan keeping her out of the top influencer score. This information is forwarded to the workflow engine which matches against the rule, “IF buy_likelihood=high AND influence=high THEN create_sales_opportunity AND assign_opportunity=closers_queue”. The system creates the sales opportunity with Susan's post, the source of the post and the minimal account information and assigns the sales opportunity to the top closers queue. Shelly is the quickest sales agent to access the closers queue and learns about Susan's interest. Shelly quickly creates an account on gadgets.com and composes a manual response on Sally's post. Shelly's response includes a link to the myRobot dealer locator site, the myRobot product pricing page, and Shelly's phone number to call if she wants immediate information.

### Example 10

myRobot Corporation uses a CRM system that automatically identifies all the product names out of the product catalog for the support system and uses those product names as search tokens against the gadgets.com site. This saves myRobot from configuring custom search terms, and also helps prevent overlooking the addition of new search terms as they regularly release new products or rebrand existing products causing a great proliferation of items in their product catalog. These changes do not affect the monitoring rules which remain consistent and allow Example 9 to work even during times of great change in the myRobot business marketing and product cycles.

### Example 11

George is a regular contributor to the peripherals.com product forum. Periphals.com recognizes the importance of their forum for both support and pre-sales of peripherals.com products so they monitor it. The monitoring system is configured to identify all authors and readers in a certain product-specific group. The system discovers George reading the posts in this monitored group. It sends George's information into the Analysis Engine. The Engine discovers that George generally posts neutral to positive content on the forum and that his posts tend to be authoritative and answers to other posters. The Engine also determines George's influencer value to match his regular usage and informative, helpful role. Finally, the CRM system is able to verify that the forum handle CuriousG matches their customer record for George with a full contact profile which has been recently updated. These discoveries are sent to the workflow engine, which matches the rule: “IF overall_sentiment=generally_positive AND influencer=moderate AND poster IN CRM THEN auto_respond IN email USING 10%_off_coupon”. Subsequently, George receives an email with a coupon for 10% off his next purchase at periphals.com.

### Example 12

Steve posts on Facebook an account of his most recent web search: “Can't find support information on my funky Mojobike.” Stylin' Bikes monitors Facebook using custom search terms for mentions of each of its bike models. Steve's post is sent to the Analysis Engine. The sentiment calculation learns that Steve always posts positive or neutral sentiment but this post is out of character as moderately negative due to the term “funky”. The influencer calculation shows Steve to have an average number of friends, but is unusually prolific with 25,753 posts. His profile is complete, giving him a slightly above average influencer score. The Stylin' Bikes CRM system has no record of Steve since he purchased his bike through his local bike shop and has (clearly) never contacted the company for support. The system sends this information to the workflow engine which matches the following rule: “IF overall_sentiment=generally_positive AND current_sentiment<=moderately_negative AND influencer>average THEN adjust_sentiment_score=increase AND auto_respond IN source_channel USING SmartResponse”. In this case the system takes Steve's post and sends it back to the sentiment calculation engine and adjusts the sentiment value upwards due to the strange rating on “funky”. The system then responds back on Facebook (using the pre-configured Stylin' Bikes corporate account attached to the corporate Stylin' Bikes Facebook page) with the top 5 Answers out of the Stylin' Bikes support content for the search term Mojobike. Steve is then able to click through on the 2nd Answer which takes him to the Stylin' Bikes support site with the answer to Steve's underlying question. Steve is also able to click through on the Stylin' Bikes user name and become a Fan on their Facebook corporate page and posts showing his satisfaction.

### Example 13

The generic term “support” is monitored as a matter of course in all configured channels of Stylin' Bikes CRM system. The product term “Mojobike” is extracted from the product catalog and combined with the generic term to identify when relevant posts occur on the configured channels. No further analysis is needed because Stylin' Bikes wants to monitor every post happening in Facebook during its initial product launch. Steve's post is discovered simply by the match to the automatically generated search query “support mojobike” and is routed into the workflow engine directly. Stylin' Bikes has configured their workflow with a rule: “IF source_channel=FACEBOOK THEN assign_incident=facebook_queue” which is matched by Steve's post and routed to a team of Stylin' Bikes agents working to support their growing consumer base in any way possible. These agents can then respond in the Facebook channel or identify Steve's credentials and contact him via other means.

The examples provided above are not intended to be an exhaustive explanation of each possible operation of the systems and methods described herein, and the various embodiments are not limited to any example described above.

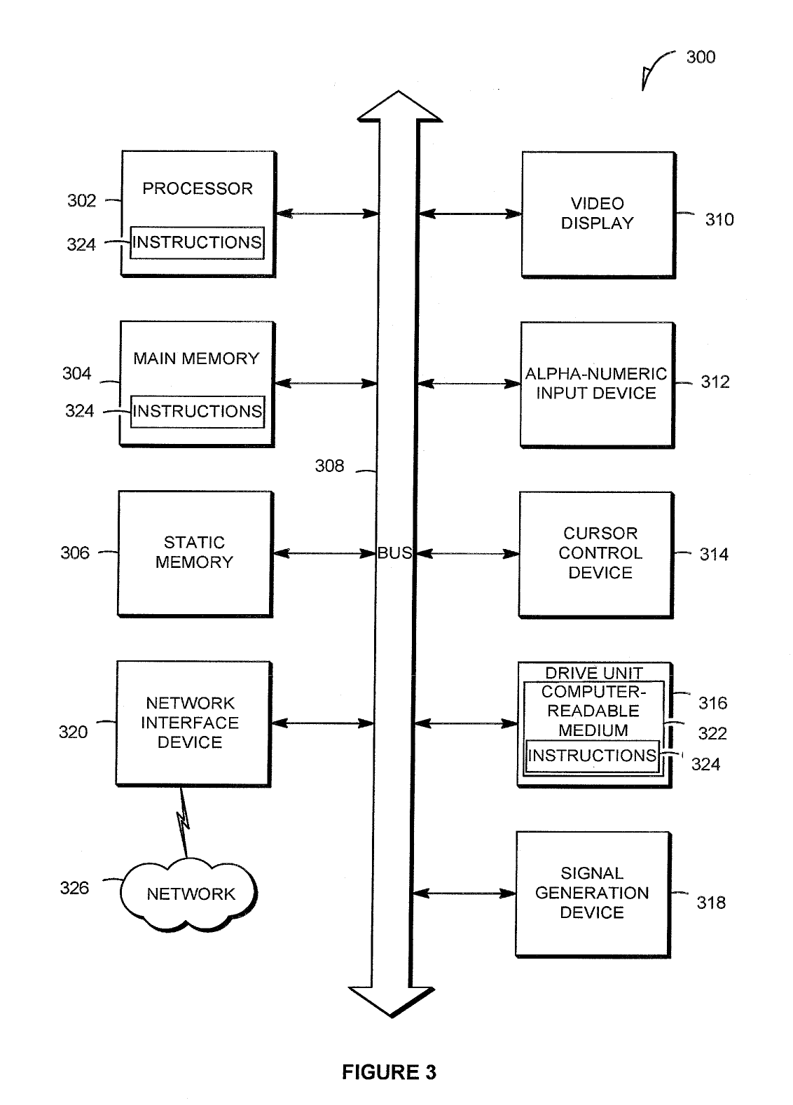

FIG. 3 is a block diagram of an example embodiment of a computer system 300 upon which embodiments inventive subject matter can execute. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 3 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 3, a hardware and operating environment is provided that is applicable to both servers and/or remote clients.

With reference to FIG. 3, an example embodiment extends to a machine in the example form of a computer system 300 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 300 may include a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). In example embodiments, the computer system 300 also includes one or more of an alpha-numeric input device 312 (e.g., a keyboard), a user interface (UI) navigation device or cursor control device 314 (e.g., a mouse), a disk drive unit 316, a signal generation device 318 (e.g., a speaker), and a network interface device 320.

The disk drive unit 316 includes a machine-readable medium 322 on which is stored one or more sets of instructions 324 and data structures (e.g., software instructions) embodying or used by any one or more of the methodologies or functions described herein. The instructions 324 may also reside, completely or at least partially, within the main memory 304 or within the processor 302 during execution thereof by the computer system 300, the main memory 304 and the processor 302 also constituting machine-readable media.

While the machine-readable medium 322 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media that can store information in a non-transitory manner, i.e., media that is able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 324 may further be transmitted or received over a communications network 326 using a transmission medium via the network interface device 320 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A method for execution by one or more processors, the method comprising:
receiving a content item from a communication channel; and
upon determining that the content item is to be processed further, performing the actions of
performing semantic analysis on the content item,
calculating an influence rating for the content item, and
determining an action in accordance with the semantic analysis and the influence rating.

2. The method of claim 1, wherein determining that the content item is to be processed further comprises one or more of identifying a trigger token or identifying a match to at least one search term.

3. The method of claim 2, wherein the trigger token comprises one or more of a generic trigger token, an entity name trigger token, or a product or service name trigger token.

4. The method of claim 2, wherein the action comprises routing the content item to a system, wherein the system is selected in accordance with the trigger token.

5. The method of claim 2, wherein the trigger token is automatically determined.

6. The method of claim 1, and further comprising receiving proprietary data for an originator of the content item; and wherein the action is further determined in accordance with the proprietary data.

7. The method of claim 6, and further comprising determining a business value from the proprietary data; and wherein the action is further determined in accordance with the business value.

8. The method of claim 1, wherein determining an action includes one or more of selecting a communications channel for communicating a response to the content item, escalating a priority, routing the content item, updating one or more parameters used to calculate sentiment or influence rating, pushing the content to an alternate medium or generating an automated response.

9. The method of claim 8, wherein selecting a communications channel for communicating the response includes selecting a communications channel in accordance with one or more characteristics of the response.

10. The method of claim 8, wherein routing the content item includes routing the content item to one or more of an agent selected according to an agent skill, a manual responder, or a queue.

11. A method for execution by one or more processors, the method comprising:
receiving a content item from a communication channel;
determining that the content item is to be processed further based on the presence of a trigger token in the content item; and
upon determining that the content item is to be processed further, determining an action in accordance with the trigger token.

12. The method of claim 11, wherein the trigger token comprises one or more of a generic trigger token, an entity name trigger token, or a product or service name trigger token.

13. The method of claim 11, wherein the action comprises routing the content item to a system, wherein the system is selected in accordance with the trigger token.

14. The method of claim 11, wherein the trigger token is automatically determined.

15. The method of claim 11, wherein determining an action includes one or more of selecting a communications channel for communicating a response to the content item, escalating a priority, routing the content item, updating one or more parameters used to calculate sentiment or influence rating, escalating a priority for a work item, pushing the content to an alternate medium or generating an automated response.

16. The method of claim 15, wherein selecting a communications channel for communicating the response includes selecting a communications channel in accordance with one or more characteristics of the response.

17. The method of claim 15, wherein routing the content item includes routing the content item to one or more of an agent selected according to an agent skill, a manual responder, or a queue.

18. A system comprising:
one or more processors;
a content monitor executable by the one or more processors to receive a content item from one or more of a plurality of communication channels and to determine if the content item is to be processed further;
an analysis engine executable by the one or more processors to receive a content item from the content monitor and to perform operations comprising:
semantically analyze the content item, and
calculate an influence rating for the content item; and
a workflow engine executable by the one or more processors to determine an action in accordance with the semantic analysis and the influence rating.

19. The system of claim 18, wherein the content monitor determines that the content item is to be processed upon one or more of identifying a trigger token or identifying a match to at least one search term.

20. The system of claim 18, wherein the trigger token comprises one or more of a generic trigger token, an entity name trigger token, or a product or service name trigger token.

21. The system of claim 18, wherein the action comprises routing the content item to a system, wherein the system is selected in accordance with the trigger token.

22. The system of claim 18, and further comprising a product catalog and wherein the token is extracted from the product catalog.

23. The system of claim 18, and further comprising a database having proprietary data for an originator of the content item; and wherein the action is further determined in accordance with the proprietary data.

24. The system of claim 18, wherein the communication channel includes one or more of a social networking service, an audio channel, a video channel, an RSS feed, or a web site.

25. A non-transitory machine-readable medium having computer-executable instructions stored thereon that when executed, causes one or more processors to perform operations comprising:
receiving a content item from a communication channel; and
upon determining that the content item is to be processed further, performing the actions of:
performing semantic analysis on the content item,
calculating an influence rating for the content item, and
determining an action in accordance with the semantic analysis and the influence rating.

26. The non-transitory machine-readable medium of claim 25, wherein determining that the content item is to be processed further comprises one or more of identifying a trigger token or identifying a match to at least one search term.

27. The non-transitory machine-readable medium of claim 26, wherein the trigger token comprises one or more of a generic trigger token, an entity name trigger token, or a product or service name trigger token.

28. The non-transitory machine-readable medium of claim 26, wherein the action comprises routing the content item to a system, wherein the system is selected in accordance with the trigger token.

29. The non-transitory machine-readable medium of claim 26, wherein the trigger token is automatically determined.

29. The non-transitory machine-readable medium of claim 25, wherein the operations further comprise receiving proprietary data for an originator of the content item; and wherein the action is further determined in accordance with the proprietary data.

30. The non-transitory machine-readable medium of claim 29, wherein the operations further comprise determining a business value from the proprietary data; and wherein the action is further determined in accordance with the business value.

31. The non-transitory machine-readable medium of claim 25, wherein determining an action includes one or more of selecting a communications channel for communicating a response to the content item, updating one or more parameters used to calculate sentiment or influence rating, pushing the content to an alternate medium, escalating a priority, routing the content item, or generating an automated response.

32. The non-transitory machine-readable medium of claim 31, wherein selecting a communications channel for communicating the response includes selecting a communications channel in accordance with one or more characteristics of the response.

33. The non-transitory machine-readable medium of claim 31, wherein routing the content item includes routing the content item to one or more of an agent selected according to an agent skill, a manual responder, or a queue.
